(19) United States
(12) Patent Application Publication
(10) Pub. No.: US 2026/0127849 A1
(43) Pub. Date: May 7, 2026

(54) SIMILARITY DETECTION SYSTEM AND METHOD

(71) Applicant: Himax Technologies Limited, Tainan City (TW)

(72) Inventor: Ming-Chih Wang, Tainan City (TW)

(21) Appl. No.: 18/938,821

(22) Filed: Nov. 6, 2024

(51) Int. Cl. G06V 10/74; G06V 10/56; H04N 5/265

(52) U.S. Cl. CPC G06V 10/761; G06V 10/56; H04N 5/265

(57) ABSTRACT

A similarity detection system includes at least one summation device that sums video data of a current frame, thereby generating a current sum associated with the current frame, the summation device applying a set of different weights for pixel values of the video data at different locations; at least one difference device that generates a difference between the current sum and a reference sum; and at least one comparator that compares the difference with a predetermined threshold, thereby generating a comparison result indicating similarity between the video data of the current frame and reference video data.

### BACKGROUND OF THE INVENTION

### 1. Field of the Invention

The present invention generally relates to similarity detection, and more particularly to a similarity detection system and method capable of detecting frozen screen and on-screen display (OSD).

### 2. Description of Related Art

The significance of frozen screen detection in in-vehicle display modules cannot be overstated, as it is a critical part of functional safety in modern vehicles. For example, the rearview mirror is a critical component for drivers to maintain awareness of their surroundings and traffic conditions. A frozen rearview mirror that becomes unresponsive and stops updating may potentially lead to dangerous misjudgment of distances and the positions of other vehicles. As another example, if the speedometer on the dashboard loses updates and remains unchanged, drivers may become confused and put themselves in danger.

In the realm of video data processing, particularly when dealing with color depth conversion (for example, converting from 10-bit to 8-bit), as a generic concept of dithering, the converted 8-bit data will follow the least-significant-bit (LSB) change (or dithering) of the original 10-bit data. The dithering may introduce minor disturbances or errors. These slight alterations in pixel values necessitate robust frozen screen detection methods that can discern between these expected changes and actual screen freezing events, particularly for in-vehicle display modules without frame buffer for the purpose of reduced cost and simplified design. Traditional techniques like Cyclic Redundancy Check (CRC) may miss detection of a frozen screen due to disturbances or errors caused by dithering. Conversely, methods such as checksum can lead to false alarms due to distinct frames with the same sum. On the other hand, in a display module with frame buffer, screen freezing events can be easily detected by comparing video data of the current frame with video data of the previous frame stored in the frame buffer, but the chip cost will be higher due to the frame buffer.

The accuracy of on-screen displays (OSD) in vehicles is indeed a critical component of functional safety, especially as we move towards higher levels of vehicular autonomy. As in-vehicle display technology advances, the integration of accurate and reliable OSDs becomes imperative to ensure that drivers and autonomous systems have precise information about the vehicle's status and the surrounding environment. This is crucial for preventing misjudgments, which could lead to accidents. The reliability of these systems directly impacts the effectiveness of OSDs in conveying critical information, thereby playing a substantial role in maintaining and improving road safety.

A need has thus arisen to propose a novel scheme capable of improving the reliability of frozen screen detection and OSD correctness detection. The proposal of the novel scheme reflects the automotive industry's commitment to leveraging technology for safety and underscores the importance of reliable frozen screen and OSD detection mechanisms.

### SUMMARY OF THE INVENTION

In view of the foregoing, it is an object of the embodiment of the present invention to provide a similarity detection system and method with enhanced and accurate detection of frozen screen or on-screen display (OSD) particularly adaptable to an in-vehicle display device without frame buffer.

According to one embodiment, a similarity detection system includes at least one summation device, at least one difference device and at least one comparator. The summation device sums video data of a current frame, thereby generating a current sum associated with the current frame, the summation device applying a set of different weights for pixel values of the video data at different locations. The difference device generates a difference between the current sum and a reference sum. The comparator compares the difference with a predetermined threshold, thereby generating a comparison result indicating similarity between the video data of the current frame and reference video data.

### BRIEF DESCRIPTION OF THE DRAWINGS

FIG. 1A shows a block diagram illustrating a similarity detection system according to one embodiment of the present invention;

FIG. 1B shows a block diagram illustrating a similarity detection system according to an alternative embodiment of the present invention;

FIG. 1C shows a block diagram illustrating a similarity detection system according to an alternative embodiment of the present invention;

FIG. 2 shows a block diagram illustrating a digital image processing system adopting the similarity detection system of FIG. 1A, FIG. 1B or FIG. 1C according to one exemplary embodiment of the present invention; and

FIG. 3 shows a block diagram illustrating a digital image processing system adopting the similarity detection system of FIG. 1A, FIG. 1B or FIG. 1C according to another exemplary embodiment of the present invention.

### DETAILED DESCRIPTION OF THE INVENTION

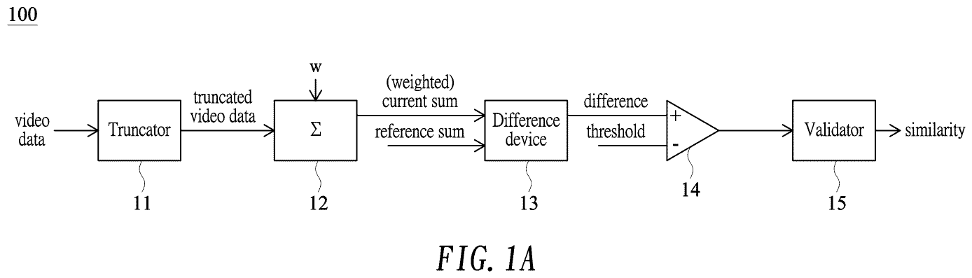

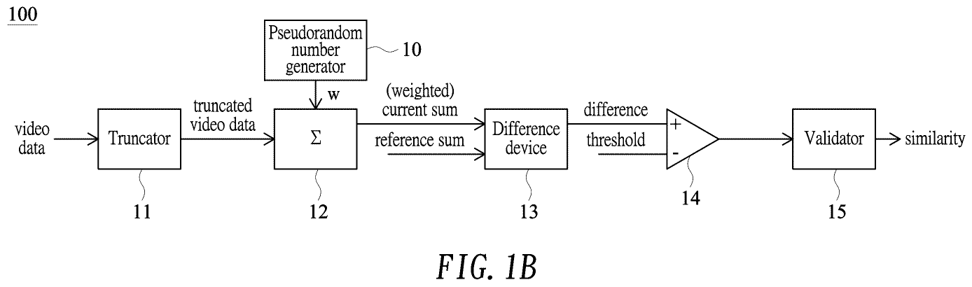

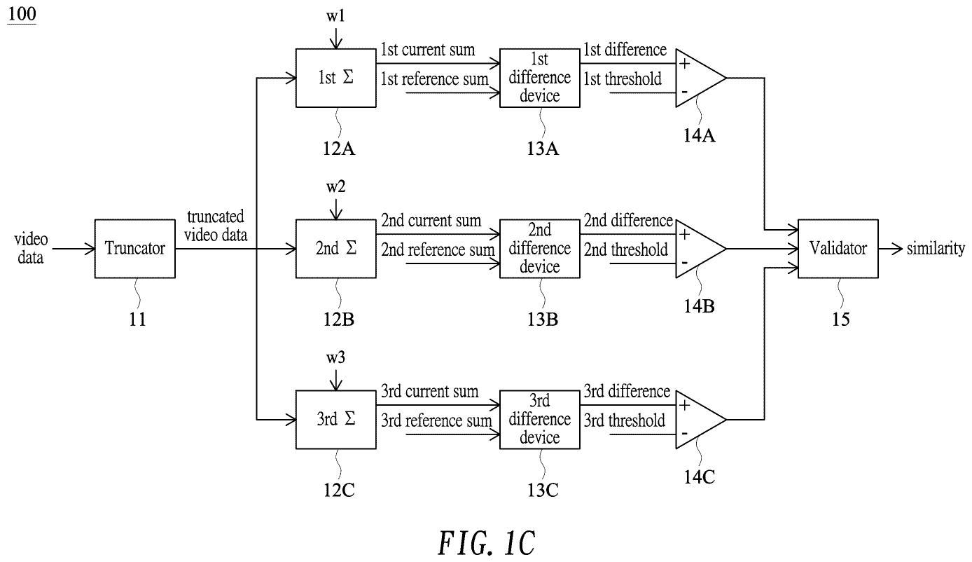

FIG. 1A shows a block diagram illustrating a similarity detection system 100 according to one embodiment of the present invention. The blocks of the similarity detection system 100 may be implemented by hardware (e.g., circuitry), software (e.g., programs) or their combinations. For example, the similarity detection system 100 may be performed in a digital image processor.

Specifically, the similarity detection system 100 of the embodiment may optionally include a truncator 11 coupled to receive video data (of an image) and configured to truncate (or discard) at least one least significant bit (LSB), for example, discarding one or two LSBs, of each pixel value of the video data, thereby resulting in truncated video data. As least significant bit or bits are truncated, disturbance or error that exists in the video data may be substantially reduced without significant impact on the recognition of the image. It is noted that the video data mentioned above may constitute an entire frame or part of the frame.

In the embodiment, the similarity detection system 100 may include a summation device 12 configured to sum (or add) the truncated video data of a current frame, thereby generating a current sum associated with the current frame. According to one aspect of the embodiment, the summation device 12 applies (a set of) different weights w (or gains) for pixel values (of the video data) at different locations (of the frame), thereby generating a weighted current sum. The different weights may be set specifically. In one exemplary embodiment, larger weights are applied to highlight specific objects. In another exemplary embodiment, larger weights are applied to enhance specific features, such as edges, textures, or details.

Alternatively, the different weights may be generated randomly, for example, by a pseudorandom number generator. FIG. 1B shows a block diagram illustrating a similarity detection system 100 according to an alternative embodiment of the present invention. The block diagram of FIG. 1B is similar to the block diagram of FIG. 1A except for the following differences. In the embodiment of FIG. 1B, the similarity detection system 100 may include a pseudorandom number generator 10 configured to generate a sequence of random numbers as weights at different positions (of the frame).

In the embodiment, the similarity detection system 100 may include a difference device 13 configured to generate a difference between the current sum (associated with the current frame) and a reference sum serving as reference or golden data. The similarity detection system 100 may include a comparator 14 configured to compare the difference with a predetermined threshold, thereby generating a comparison result, indicating similarity between the video data of the current frame and reference video data. The reference sum mentioned above may be stored in a temporary storage device such as a register (not shown). The similarity detection system 100 may include a validator 15 configured to determine similarity of the video data according to the comparison result. If the difference is less than the predetermined threshold, similarity of the video data is confirmed, otherwise unsimilarity of the video data is confirmed.

FIG. 1C shows a block diagram illustrating a similarity detection system 100 according to an alternative embodiment of the present invention. The block diagram of FIG. 1C is similar to the block diagram of FIG. 1A except for the following differences.

In the embodiment of FIG. 1C, the similarity detection system 100 may include a plurality of summation devices 12A-12C with different sets of weights (e.g., w1-w3), each configured to sum the truncated video data of a current frame with a corresponding set of weights, thereby generating a corresponding current sum.

The similarity detection system 100 of FIG. 1C may include a plurality of difference devices 13A-13C each configured to generate a corresponding difference between the corresponding current sum (associated with the current frame) and a corresponding reference sum.

The similarity detection system 100 of FIG. 1C may include a plurality of comparators 14A-14C, each configured to compare the corresponding difference with a corresponding predetermined threshold, thereby generating a corresponding comparison result.

The similarity detection system 100 of FIG. 1C may include a validator 15 configured to determine similarity of the video data according to all the comparison results (of the comparators 14A-14C). If every difference is less than the corresponding predetermined threshold, similarity of the video data is confirmed, otherwise unsimilarity of the video data is confirmed. Compared to FIG. 1A or FIG. 1B, as multiple summation devices 12A-12C, multiple difference devices 13A-13B and multiple comparators 14A-14C are adopted, missed or false detection of similarity can be substantially reduced.

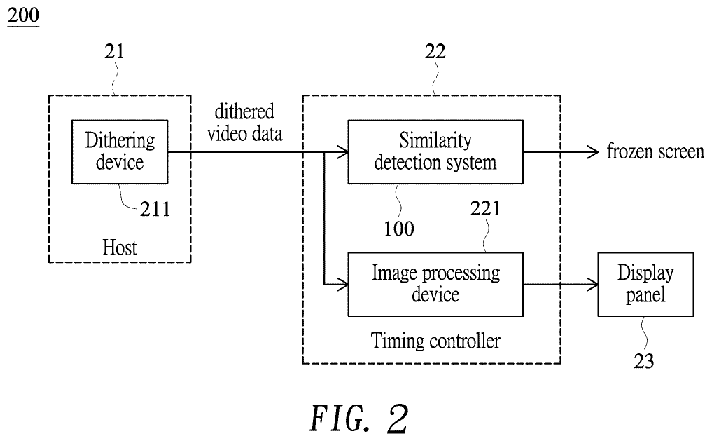

FIG. 2 shows a block diagram illustrating a digital image processing system 200 adopting the similarity detection system 100 of FIG. 1A, FIG. 1B or FIG. 1C according to one exemplary embodiment of the present invention. The digital image processing system 200 may be adapted to, but not limited to, an in-vehicle display device for detecting frozen screen.

In the embodiment, the digital image processing system 200 of the embodiment may include a host 21 that acts as a main computing device, and a timing controller 22 that synchronizes and controls timing of data transmission between the host 21 and a display panel 23.

Specifically, the host 21 may include a dithering device 211 (or a color depth converter in general) configured to convert video data (or pixel values of an image) from one color depth (also known as bit depth) to another color depth (e.g., from 24-bit to 8-bit) and mitigate quantization errors (caused by the color depth conversion) by introducing controlled noise used to randomize the quantization errors and simulate additional colors or shades, thereby resulting in dithered video data with smoother transitions between colors. Color depth (or bit depth) refers to the number of bits used to represent each pixel in an image. It determines the range of colors that can be displayed. However, color depth conversion may lead to quantization errors. For example, when converting from a higher depth to a lower depth, some color information is lost due to quantization errors. However, dithering may commonly lead to disturbance or error on least significant bit or bits.

As shown in FIG. 2, the dithered video data is subject to similarity detection of the similarity detection system 100 (of FIG. 1A, FIG. 1B or FIG. 1C) disposed in the timing controller 22. It is noted that the reference sum (of the similarity detection system 100) represents a previous (weighted) sum associated with a previous frame. If similarity is confirmed by the similarity detection system 100, a frozen screen is detected. The timing controller 22 may include at least one image processing device 221 configured to process the dithered video data and send processed video data to the display panel 23.

The digital image processing system 200 can detect frozen screen in the dithered video data for maintaining system reliability and user experience, thereby generating a detection result indicating whether frozen screen is detected. The similarity detection system 100 is especially suitable for a real time digital image processing system 200 that does not contain a frame buffer (or video buffer) used to hold the previous frame.

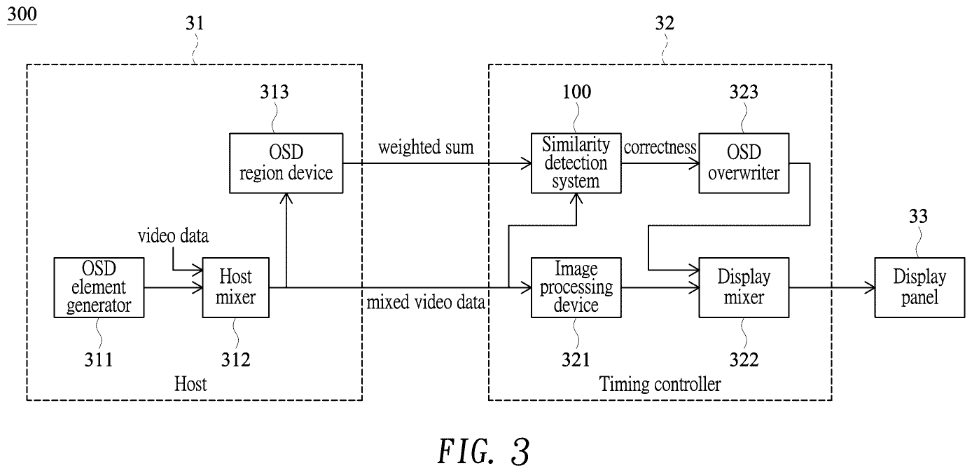

FIG. 3 shows a block diagram illustrating a digital image processing system 300 adopting the similarity detection system 100 of FIG. 1A, FIG. 1B or FIG. 1C according to another exemplary embodiment of the present invention. The digital image processing system 300 may be adapted to, but not limited to, an in-vehicle display device for detecting correctness of on-screen display (OSD).

In the embodiment, the digital image processing system 300 of the embodiment may include a host 31 that acts as a main computing device, and a timing controller 32 that synchronizes and controls timing of data transmission between the host 31 and a display panel 33.

Specifically, the host 31 may include an on-screen display (OSD) element generator 311 configured to generate an OSD element such as icon, text, graphic or other visual information. The host 31 may include a host mixer 312 configured to overlay the OSD element on (original) video data (of a frame), thereby resulting in mixed video data. The host 31 may include an OSD region device 313 configured to generate a weighted sum of an OSD region of the mixed video data, along with size and location associated with the OSD region.

The timing controller 32 may include at least one image processing device 321 configured to process the mixed video data and then send processed video data to the display panel 33 via a display mixer 322.

As shown in FIG. 3, the mixed video data received by the timing controller 32 is subject to similarity detection of the similarity detection system 100 (of FIG. 1A, FIG. 1B or FIG. 1C) disposed in the timing controller 32. It is noted that the weighted sum generated by the OSD region device 313 is used as the reference sum or golden data (for the similarity detection system 100). If similarity is confirmed by the similarity detection system 100, correctness of the OSD element is detected (or confirmed). If unsimilarity is confirmed by the similarity detection system 100, an OSD overwriter 323 may be activated to generate a predetermined OSD element, which is overlaid on the processed video data (from the image processing device 321) by the display mixer 322 prior to sending to the display panel 33.

The digital image processing system 300 can detect correctness of the OSD element for maintaining system reliability and user experience, thereby generating a detection result indicating whether the OSD element is correct. The similarity detection system 100 is especially suitable for a real-time digital image processing system 300 that does not contain a frame buffer (or video buffer) used to hold the previous frame. In the embodiment of FIG. 2, the difference device 13 of the similarity detection system 100 generates the difference between the current sum (associated with the entire current frame) and the reference sum (associated with the previous frame). On the other hand, in the embodiment of FIG. 3, the difference device 13 of the similarity detection system 100 generates the difference between the current sum (associated with the current OSD region) and the reference sum (associated with the golden data from the OSD region device 313).

Although specific embodiments have been illustrated and described, it will be appreciated by those skilled in the art that various modifications may be made without departing from the scope of the present invention, which is intended to be limited solely by the appended claims.

What is claimed is:

1. A similarity detection system, comprising:
at least one summation device that sums video data of a current frame, thereby generating a current sum associated with the current frame, the summation device applying a set of different weights for pixel values of the video data at different locations;
at least one difference device that generates a difference between the current sum and a reference sum; and
at least one comparator that compares the difference with a predetermined threshold, thereby generating a comparison result indicating similarity between the video data of the current frame and reference video data.

2. The system of claim 1, further comprising:
a truncator that truncates at least one least significant bit (LSB) of each pixel value of the video data before the video data is received by the summation device.

3. The system of claim 1, further comprising:
a validator that determines similarity of the video data according to the comparison result;
wherein similarity of the video data is confirmed, if the difference is less than the predetermined threshold.

4. The system of claim 1, wherein the at least one summation device comprises a plurality of summation devices with different sets of weights, each configured to sum the video data of the current frame with a corresponding set of weights, thereby generating a corresponding current sum.

5. The system of claim 4, wherein the at least one difference device comprises a plurality of difference devices, each configured to generate a corresponding difference between the corresponding current sum and a corresponding reference sum.

6. The system of claim 5, wherein the at least one comparator comprises a plurality of comparators, each configured to compare the corresponding difference with a corresponding predetermined threshold, thereby generating a corresponding comparison result.

7. The system of claim 6, further comprising:
a validator that determines similarity of the video data according to all comparison results;
wherein similarity of the video data is confirmed, if every difference is less than the corresponding predetermined threshold.

8. The system of claim 1, further comprising:
a dithering device that converts the video data from one color depth to another color depth and performs dithering on the video data before the video data is received by the summation device.

9. The system of claim 8, wherein a frozen screen is detected, if similarity is confirmed according to the comparison result.

10. The system of claim 1, further comprising:
an on-screen display (OSD) element generator that generates an OSD element;
a host mixer that overlays the OSD element on original video data, thereby resulting in mixed video data; and
an OSD region device that generates a weighted sum of an OSD region of the mixed video data as the reference sum.

11. The system of claim 10, wherein correctness of the OSD element is detected, if similarity is confirmed according to the comparison result.

12. The system of claim 11, further comprising:
at least one image processing device that processes the mixed video data, thereby resulting in processed video data;
an OSD overwriter that generates a predetermined OSD element, the OSD overwriter being activated when similarity is not confirmed; and
a display mixer that overlays the predetermined OSD element on the processed video data.

13. The system of claim 1, further comprising:
a pseudorandom number generator that generates a sequence of random numbers as the set of different weights.

14. A similarity detection method, comprising:
summing video data of a current frame with a set of different weights for pixel values of the video data at different locations, thereby generating a current sum associated with the current frame;
generating a difference between the current sum and a reference sum; and
comparing the difference with a predetermined threshold, thereby generating a comparison result indicating similarity between the video data of the current frame and reference video data.

15. The method of claim 14, further comprising:
truncating at least one least significant bit (LSB) of each pixel value of the video data before the current sum is generated.

16. The method of claim 14, further comprising:
determining similarity of the video data according to the comparison result;
wherein similarity of the video data is confirmed, if the difference is less than the predetermined threshold.

17. The method of claim 14, further comprising:
converting the video data from one color depth to another color depth and performing dithering on the video data before the current sum is generated;
wherein a frozen screen is detected, if similarity is confirmed according to the comparison result.

18. The method of claim 14, further comprising:
generating an on-screen display (OSD) element;
overlaying the OSD element on original video data, thereby resulting in mixed video data; and
generating a weighted sum of an OSD region of the mixed video data as the reference sum.

19. The method of claim 18, wherein correctness of the OSD element is detected, if similarity is confirmed according to the comparison result.

20. The method of claim 19, further comprising:
processing the mixed video data, thereby resulting in processed video data;
generating a predetermined OSD element; and
overlaying the predetermined OSD element on the processed video data only when similarity is not confirmed.

21. The method of claim 14, further comprising:
generating a sequence of pseudorandom numbers as the set of different weights.
